(19) United States
(12) Patent Application Publication
(10) Pub. No.: US 2017/0156545 A1
(43) Pub. Date: Jun. 8, 2017

(54) ROLLER GRILL

(71) Applicant: Raymond E. Davis, Dallas, TX (US)

(72) Inventor: Raymond E. Davis, Dallas, TX (US)

(21) Appl. No.: 14/960,588

(22) Filed: Dec. 7, 2015

(51) Int. Cl. A47J 37/04

(52) U.S. Cl. CPC A47J 37/048

(57) ABSTRACT

A roller grill for hot dogs and other comestibles possessing a cabinet having an array of rotationally driven heat tubes, each with an outer surface heated by an internal heating element. Mounting plates at sides of the roller grill are configured to support a plurality of axles that are adapted to mate with a gear at distal ends of each heat tube. The gears of the heat tubes are held in parallel alignment by the axles, and are driven by one or more idler gears and one or more drive gears powered by one or more motors. Disposed between an output shaft of the motor and a drive gear, is a slip clutch that disengages power to the drive gear and thereby pauses rotation of the heat tubes if enough rotational resistance is encountered. Heat containment panels with a curvature on an uppermost portion are mountable to sides of the roller grill to reduce heat loss from the peripheral rows of heat tubes and thereby stabilize the temperature gradient of the heat tube array.

### TECHNICAL BACKGROUND

This disclosure relates to a roller grill or griddle for heating and/or reheating pre-cooked food product.

### BACKGROUND

Various apparatus are used to heat and/or reheat prepared consumer pre-cooked food products. In some instances, cylindrically shaped pre-cooked food products, such as hotdogs, tacquitos, cheese burger bites, and sausage links, may be prepared using a roller grill apparatus, which may include a number of heated, rotating tubes upon which the pre-cooked food products rest and rotate. While the heat conducting and/or radiating from the tubes and the rotation of the tubes allow the pre-cooked food products to be heated substantially uniformly, these features can also impose detrimental effects on other components of the roller grill apparatus. For example, heat conducted and/or radiated from the ends of the tubes is transferred to rotating drive mechanism components in contact with the ends of the tubes, such as chains, lubricants, bearings, and other components. The heat conducted and/or radiated through these components, as well as the mechanical engagement of these components with one another during operation of the roller grill apparatus, can cause gradual deterioration and eventual failure of such components.

Conventionally, roller grills and/or griddles used for heating and/or reheating pre-cooked food products have used chain drive assemblies to drive (e.g., rotate) tubular heating surfaces on which the pre-cooked food products may be placed. The chain drive assemblies typically utilize a metallic chain that engages metallic sprockets mounted on the tubular heating surfaces. Due in part to the metal-on-metal contact, as well as the heat energy conducted through and/or radiated from the sprockets and chain from the tubular heating surfaces (and other components of conventional roller grills), the chain drive assembly may require regular maintenance (e.g., lubrication, adjustment of the chain and/or the sprockets to maintain suitable engagement, and otherwise). Without such regular maintenance, conventional roller grills often experience high failure rates.

In some instances, pre-cooked food products must be heated to a minimum internal temperature in order to, for example, kill bacteria that can cause food related illness. For instance, certain standards (e.g., NSF International) have been established that require pre-cooked food product to be heated to a minimum internal temperature for safety reasons.

U.S. Pat. No. 8,857,319 B2, U.S. Pat. No. 8,857,320 B2, U.S. Pat. No. 8,857,321 B2, and U.S. Pat. No. 8,857,322 B2 share at least one of the inventors listed in the instant application and having a issue date of Oct. 14, 2014 are related to the instant application and teach or claim inter alia, certain aspects, features and objects of the following disclosure. Accordingly, the foregoing patents contain essential matter necessary to the understanding of the instant application, and are herein incorporated by reference in their entirety. In particular, U.S. Pat. No. 8,857,319 claims: A roller grill for heating a pre-cooked food product, comprising: a housing structure adapted to support the roller grill; a plurality of tubes having outer surfaces adapted to transfer heat to a pre-cooked food product; a plurality of tube gears, at least one tube gear mounted on an end of a corresponding tube; and a beltless drive assembly, comprising: a motor comprising a shaft adapted to rotate at a first rotational speed; a fan to circulate airflow between a volume of a side housing of the housing structure and an ambient space to cool a plenum panel mounted in the side housing; a plurality of idler gears mounted to a portion of the housing structure and contactingly engaged with the plurality of tube gears, the idler gears adapted to transfer a rotational power from the motor to all of the plurality of tube gears at a second rotational speed and at a common rotational direction; a drive gear coupled to the shaft of the motor, the drive gear adapted to transfer the rotational power from the motor to the plurality of idler gears; and at least one transfer gear in contacting engagement with at least one idler gear of the plurality of idler gears and adapted to transfer the rotational power from the drive gear to the at least one idler gear, wherein the plenum panel serves as a heat sink to receive heat from one or more of the plurality of tubes, the plenum panel mounted within the volume at least partially defined by a side panel of the housing structure, and at least one of the plurality of idler gears is mounted to the plenum panel, the plenum panel comprising at least one aperture permitting airflow between the volume and the ambient space, and the motor and the fan are mounted beneath the plurality of tubes in a bottom housing of the housing structure to permit airflow between the side housing and the ambient space.

While the roller grill with beltless drive assembly disclosed and claimed in the (U.S. Pat. No. 8,857,319) patent offers significant advantages over the prior art, certain improvements to the roller grill that advantageously prolong the grill life, prevent damage to grill components if one or more of the heat tubes are jammed, greatly reduces energy consumption and provide for more accurate temperature control of the grill surface are disclosed herein.

### SUMMARY

The roller grill of the present invention shares certain aspects with the aforementioned patents including an array of parallel rolling heating tubes which are rotationally driven by a plurality of gears powered by a motor. In various embodiments disclosed herein according to the present invention, one or more axle mounting plates are disposed at the opposite ends of the tubes. Within the one or mounting plates are plural apertures, each aperture configured to seat a first portion of a tube axle wherein a second portion of the tube axle is configured to seat to an end of a roller tube tube. The tube axles provide dynamic self-centering of the tubes about a resting axis, yet permits the tube gears mounted over the tube axles to dynamically shift slightly out of alignment when to prevent gear binding.

In various embodiments, the powering motor for rotationally driving the heating tubes possesses a gear clutch coupled with the driving gear that allows the driving gear to slip if any one of the array of heating tubes is prevented from turning.

In various embodiments, a front and rear panel directs heat toward the heating tube array and provides heat containment, with the result of relatively low Delta-T across the tube array heat zone(s).

The foregoing aspects, objects and features result in a roller grill that uses (%) electricity than units of comparable capacity.

In one general embodiment, a roller grill for heating a pre-cooked food product includes a housing structure adapted to support the roller grill; a plurality of tubes having outer surfaces adapted to transfer heat to a pre-cooked food product; a plurality of tube gears, at least one tube gear mounted on an end of a corresponding tube; and a drive assembly. The drive assembly includes one or more motors having a shaft adapted connected to a slip gear clutch assembly that powers at a first rotational speed a plurality of idler gears mounted to a portion of the housing structure and contactingly engaged with the plurality of tube gears, the idler gears adapted to transfer a rotational power from the motor to the plurality of tube gears at a second rotational speed.

Further, combined with the foregoing general embodiment, it is found that a plurality of heat tube axles mounted and pre-aligned to at least one mounting plate affixed to sides of the roller grill frame precisely parallely aligns the heat tubes and ensures proper gear teeth mating. An annulus at the distal ends of each tube is seated over a corresponding tube axle, with each tube gear circumjacent each tube axle which permits the roller grill drive assembly to operate using considerably less force. Because frictional resistance is substantially lowered, the foregoing configuration permits the use of a single motor to drive the entire heating tube array of the roller grill tube assembly.

In a first aspect combinable with the general embodiment, the first and second rotational speeds are substantially identical.

A second aspect combinable with any of the previous aspects includes drive gear coupled to the shaft of the motor, the drive gear adapted to transfer the rotational power from the motor to the plurality of idler gears.

A third aspect combinable with any of the previous aspects includes at least one transfer gear in contacting engagement with at least one of the idler gears and adapted to transfer the rotational power from the drive gear to the least one of the plurality of idler gears.

In a fourth aspect combinable with any of the previous aspects, the second rotational speed is less than the first rotational speed.

In a fifth aspect combinable with any of the previous aspects, the at least one transfer gear includes at least one reduction gear adapted to reduce the first rotational speed to the second rotational speed.

In a sixth aspect combinable with any of the previous aspects, the housing structure includes a side housing.

In an eighth aspect combinable with any of the previous aspects, the plurality of tubes are mounted through the side housing, and the plurality of idler gears are mounted to the side housing.

In a ninth aspect combinable with any of the previous aspects, the side housing includes a plurality of studs extending from the side housing into a plenum defined by the side housing without penetrating through the side housing.

In a tenth aspect combinable with any of the previous aspects, each of the plurality of idler gears is mounted on a corresponding one of the plurality of studs.

In an eleventh aspect combinable with any of the previous aspects, the housing structure includes a plenum panel mounted within a volume at least partially defined by a side panel of the housing structure.

In a twelfth aspect combinable with any of the previous aspects, each of the plurality of idler gears is mounted to the plenum panel.

In a thirteenth aspect combinable with any of the previous aspects, the plenum panel comprises a heat sink receiving heat from one or more of the plurality of heating tubes.

In a fourteenth aspect combinable with any of the previous aspects, the heat received from the plenum panel is transferred from one or more of the plurality of heating tubes through one or more of the plurality of tube gears and one or more of the idler gears.

In a fifteenth aspect combinable with any of the previous aspects, the plenum plate includes at least one aperture permitting airflow between the volume at least partially defined by the side panel of the housing structure and an ambient space.

In a sixteenth aspect combinable with any of the previous aspects, at least one of the tube gears and the idler gears comprises a spur gear.

In a seventeenth aspect combinable with any of the previous aspects, each tube gear includes a corresponding first axis of rotation.

In an eighteenth aspect combinable with any of the previous aspects, the drive gear includes a second axis of rotation.

In a nineteenth aspect combinable with any of the previous aspects, the first axes of rotation are substantially parallel to the second axis of rotation.

A twentieth aspect combinable with any of the previous aspects includes a plurality of heating elements.

In a twenty-first aspect combinable with any of the previous aspects, at least one of the plurality of heating elements extends through a bore of one of the heating tubes.

In a twenty-second aspect combinable with any of the previous aspects, each of the plurality of tubes includes a heating surface having a length of approximately 32.5 inches (82.6 cm).

In a twenty-third aspect combinable with any of the previous aspects, the plurality of tubes includes at least 16 tubes.

In a twenty-fourth aspect combinable with any of the previous aspects, at least one of the tube gears or idler gears comprises a self-lubricating gear.

In a twenty-fifth aspect combinable with any of the previous aspects, the ends of the tubes may rest on an axle that permits gears about the axle to rotationally move the tubes.

In a twenty-sixth aspect combinable with any of the previous aspects, ends of the foregoing axles are nested within and collectively aligned on an axle mounting plate.

In a twenty-seventh aspect combinable with any of the previous aspects, a slip gear is positioned between the power shaft of a motor and the drive assembly which may be idler gears.

In a twenty-eighth aspect combinable with any of the previous aspects, front and back panels are provided with a raised heat deflector that contains heat in the food heating zone of the apparatus.

In a twenty-ninth aspect combinable with any of the previous aspects, the heating bed comprising the heating tubes may be divided into discrete thermally controlled zones, wherein the zones may include a front and back zone.

In a thirtieth aspect combinable with any of the other previous aspects, temperature sensing of heat zones is obtained with indirect sensing means that reads surface temperature instead of internal temperature of the heat tubes.

In a thirty-first aspect combinable with any of the previous aspects, indirect sensing means of the surface temperature of the heat tubes may be one or more infrared laser temperature sensing units communicating with an electronic temperature controller.

In a thirty-second aspect combinable with any of the previous aspects, a heat containment panel resides at the front and rear of the roller grill. The heat containment panels are curving at the top, rising just beyond the level of the heating tubes to contain heat losses at the periphery of the heating tube array, and to serve as a guard to keep customers from contacting the heating tubes. The heat containment panels serve as a platform for the attachment or resting thereon of a slidable divider frame wherein the slidable dividers are arranged transversely relative to the heating tube array and separated from contact with the heating tube array. The slidable dividers are moveable and removeable.

Various embodiments of a roller grill according to the present disclosure may include one or more of the following features. For example, the roller grill may operate in one or more selectable heating and/or reheating modes, such as a “Preparation” mode or a “Ready-to-Serve” mode. In some embodiments, the roller grill can include one or more of a cover plate and/or a plenum plate that serve as heat sinks by absorbing heat radiating from roller grill heating tubes and/or from drive assembly components included within the roller grill.

Various embodiments of a roller grill according to the present disclosure may also include one or more of the following features. For example, the roller grill may include a lubricator designed to clean and lubricate a drive chain if one is included within the roller grill, such that an appropriate amount of lubricant is provided to the drive chain during operation of the roller grill. Furthermore, the lubricator may be used with any chain-driven system that needs regular lubrication maintenance, such as a bicycle chain. In some embodiments, the roller grill may have a chain glide that causes the drive chain of the roller grill to engage more than one tooth of sprockets (e.g., sprockets located between end sprockets) included within the roller grill. This multiple tooth engagement may reduce the probability of the chain being displaced from the sprockets and reducing the frictional wear on the chain and on the sprockets. In some examples, the roller grill can include rollers that increase the engagement of the drive chain with teeth on more than one sprocket at the same time.

Various embodiments of a roller grill according to the present disclosure may also include one or more of the following features. For example, the roller grill may utilize a belt drive assembly coupled to a worm gear assembly (not shown) to rotate one or more heating tubes. In some examples, the cooling cycle can extend the life of the timing belt and/or provide the timing belt with a longer life as compared to a drive chain. In some examples, the cooling cycle can drop the temperature of the timing belt by up to 50 degrees F. In some embodiments, the cooling cycle may provide the timing belt with a life of up to six years. In some embodiments, the roller grill may utilize a direct drive assembly, thereby eliminating belts and chains.

These general and specific embodiments may be implemented using a device, system or method, or any combinations of devices, systems, or methods. The details of one or more embodiments are set forth in the accompanying drawings and the description below. Other features, objects, and advantages will be apparent from the description and drawings, and from the claims.

### DESCRIPTION OF DRAWINGS

FIGS. 1-4 illustrate views of an exemplary embodiment of a roller grill having a roller tube assembly, and a direct drive assembly utilizing a slip gear between the power shaft and plural idler gears that transfer rotational motion to a series of tube gears;

FIG. 5 in a detail side view of a roller grill, illustrates an exemplary embodiment of a gear-side axle mounting plate with axles;

FIG. 6 in a detail side view of a roller grill with axle mounting plate removed, illustrates shows an exemplary arrangement of axles, heating tubes and idler gears;

FIG. 7 is a top plan view of mounting plate (31b) with heat tube axles inserted;

FIG. 8 is a cross-sectional view of mounting plate (31b) taken along lines 8-8;

FIG. 9 is a side elevation of mounting plate (31b) with heat tube axles inserted;

FIG. 10 illustrates an exemplary embodiment of a tube axle configured to mount to an axle mounting plate;

FIG. 11 is an isometric view of mounting plate (31a) with heat tube axles inserted according to some embodiments;

FIG. 12 is an isometric view of mounting plate (31b) with heat tube axles inserted according to some embodiments;

FIG. 13 is a partial side elevation of a heating element showing connector ends according to some embodiments;

FIGS. 14 and 15 are partial perspective views showing the ends of the heating elements according to some embodiments;

FIG. 16 shows an exemplary slip gear assembly mountable to motor (24) according to some embodiments;

FIG. 17 shows a partial plan view of a heat containment panel (34a, 34b) mountable to sides of a roller grill;

FIG. 17a is an end view of the panel shown in FIG. 17 taken in the direction of arrow (a);

FIG. 18 shows a perspective view of the roller grill with transverse slidable dividers 62;

FIG. 19 is a perspective enlarged detail view of a corner of the roller grill showing the heat front heat containment panel 34a serving as a platform for the slidable divider frame 61;

### DETAILED DESCRIPTION OF THE EMBODIMENTS

### Reference Listing of the Named Elements

10 roller grill
11a and 11b plenums
12a and 12b side housings
13 bottom housing
14 heating tubes
14b outer surface heating tubes
15 pre-cooked food products
16a heat tube retainer bushing
17 heating tube gear
18 idler gears
18a idler gear axle pins
19 heating elements
19a heating element connectors
20a, 20b plenum panels
21 transfer gears
21a transfer gear axle pins
22 drive gear
23 shaft
24 motors
25 drip plate
28 ventilation holes
29 fan
30 heating tube mounting assembly
31a, 31b axle mounting plate
32 axle
33 axle annulus
34a and 34b heat containment panels
34c curved heat containment end
35 axle gear
40 slip gear
42 clutch sleeve
43 clutch gear
44 clutch nut
46 bellville washer
48 clutch washer
50 indirect temperature sensor
60 temperature controller
60a temperature controls
61 slidable divider frame
61a slidable divider frame end
62 slidable divider
63 POP advertisement
65 snap-in flange

### DEFINITIONS

This disclosure relates to apparatus for heating and/or reheating prepared consumer pre-cooked food products, and more particularly, to roller grills and/or griddles used for heating and/or reheating cylindrically shaped pre-cooked food products, such as hotdogs and sausage links. Although in some embodiments, a roller grill according to the present disclosure may only heat and/or reheat a pre-cooked food product, in other embodiments, a roller grill according to the present disclosure may cook a raw food product.

In a general embodiment, a roller grill includes two side housings, a bottom housing, and multiple heating tubes that are disposed parallel to one another, across a volume defined between upper regions of opposite panels of the two side housings, and above the bottom housing. The heating tubes are positioned sufficiently close to one another, such that their positioning allows a pre-cooked food product to simultaneously rest atop two adjacent heating tubes. The heating tubes are further designed to rotate 360 degrees and have outer surfaces that are adapted to transfer heat to pre-cooked food products, thereby allowing the heating tubes to heat and/or reheat pre-cooked food products that rest atop the heating tubes. One or more motors power a drive assembly that provides rotary motion to the heating tubes. Between the drive assembly defining a transmission, and the one or more powering motors is one or more slip gear clutch(es) that disengage drive assembly components responsible for synchronously rotating the heating tubes. The heating tubes are aligned parallel by one or more axle mounting plates that support plural axles that are configured to reside with the tube gears at distal ends of the heating tubes.

In some embodiments, a roller grill includes two side housings, a bottom housing, and multiple heating tubes that are disposed parallel to one another, across a volume defined between upper regions of opposite panels of the two side housings, and above the bottom housing. The heating tubes are positioned sufficiently close to one another, such that their positioning allows a pre-cooked food product to simultaneously rest atop two adjacent heating tubes. The heating tubes are further designed to rotate 360 degrees and have outer surfaces that are adapted to transfer heat to pre-cooked food products, thereby allowing the heating tubes to heat and/or reheat pre-cooked food products that rest atop the heating tubes. One or more motors power a drive assembly that provides rotary motion to the heating tubes. Between the drive assembly defining a transmission, and the one or more powering motors is one or more slip gear clutch(es) that disengage drive assembly components responsible for synchronously rotating the heating tubes.

In some embodiments, the roller grill may include a belt drive assembly (not shown) having worm gears that provides rotary motion to the heating tubes. For example, the belt drive assembly can be coupled to a slip gear clutch that driven by a motor that provides rotary motion to a timing belt that transfers the motion to a timing pulley, which further rotates a shaft on which worm gears are mounted and engage spur gears that are coupled to ends of the heating tubes. In some embodiments, the belt drive assembly can have timing pulleys coupled to the ends of the heating tubes and multiple idler pulleys that provide alternating heating and cooling cycles, respectively, for the timing belt during operation of the roller grill. In some examples, the timing pulleys can be maintained on the ends of the heating tubes by TEFLON™ flanges.

In some embodiments, the roller grill may have a direct drive assembly including a drive gear coupled to a slip gear clutch and in engagement with one or more transfer gears configured to transfer rotational motion of the drive gear to matched sets of gears directly coupled to heating tubes. The gears may, in some embodiments, be spur gears. In some embodiments, the gears may be helical spur gears. In some embodiments, the gears may be non-metallic, such as, for example, a high-temperature plastic, In some embodiments, for example, one or more gears directly coupled to heating tubes may be a high-temperature plastic such as, for example, polystyrene, nylon, TEFLON™., polyethylene, polypropylene, polyvinyl chloride and polytetrafluoroethylene (PTFE), and other plastic material) that has a continual duty max temperature rating of between about 250.degree. F. (121.degree. C.) and about 500.degree. F. (260.degree. C.). In some embodiments, for example, one or more transfer and/or idler gears may be a high-temperature plastic that has a continual duty max temperature rating of between about 120.degree. F. (49.degree. C.) and about 200.degree. F. (93.degree. C.).

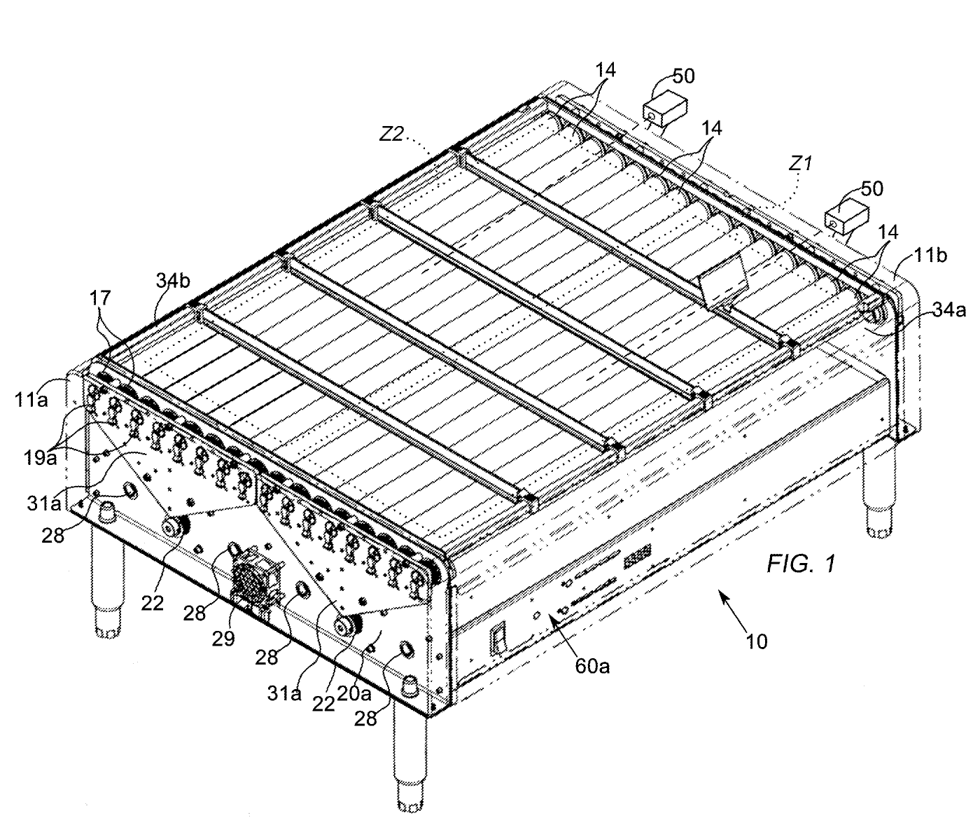

Referring generally to FIGS. 1-4, in some embodiments, the roller grill 10 may be approximately 36 inches (91 cm) in total length, and the heating tubes 14 may be approximately 35.625 inches (90.488 cm) in length. In some examples, the wall thickness of a heating tube may be between approximately 5/64 inches (0.20 cm) and approximately ⅛ inches (0.32 cm). In some examples, the width of the roller grill 10 may depend on the number of heating tubes 14 included within the roller grill 100. In some examples, the roller grill 10 can include multiple (e.g., 4, 8, 16, or other number) heating tubes 14.

In some embodiments, the heating tubes 14 have outer surfaces that are adapted to transfer heat to pre-cooked food products 15 (e.g., non-stick surfaces, cleanable surfaces, or otherwise). The heating tubes 14, in some embodiments, are further designed to rotate 360 degrees, which consequently rotates the pre-cooked food products 15 360 degrees that are in contact with the heating tubes 14. The heating tubes 14 may be heated by multiple electric resistive heat elements. In some embodiments, at least one of the electric resistive heat elements may be disposed within a bore of at least one of the heating tubes 14. In some examples, the heat conducted to the surfaces of the heating tubes 14 allows them to heat/and or reheat the pre-cooked food products 15. In some instances, the electric resistive heat elements can enable the surface temperatures of the heating tubes 14 to reach up to 300.degree. F. (149.degree. C.). In any event, the heating tubes 14 can heat the pre-cooked food products 15 to an internal temperature of about 160.degree. F. (71.degree. C.), or other temperature, to ensure that any bacteria is killed and/or eliminated.

As illustrated, the roller grill 10 may also include a drip plate 25 extending between the side housings 12a and 12b and underneath the heating tubes 14. In some embodiments, the drip plate 25 may define a bottom side of a volume extending from directly underneath the heating tubes 14 to the drip plate 25 and between the side housings 12a and 12b. Such a volume, in some embodiments, may define a sanitary volume into which no mechanical components of the roller grill 10 (e.g., gears, motors, shafts, and other components) may extend. The drip plate 25 may, in some embodiments, be a cleanable surface that catches drippings and other solids and/or liquids from the pre-cooked food product 15.

In some embodiments, the roller grill 10 can include a controller that sets the roller grill 10 to operate in one or more heating modes. For example, the heating modes may include a “Preparation” mode that heats pre-cooked food products 15 to a set minimum preparation temperature (e.g., 160.degree. F. (71.degree. C.) internal) or a “Ready-to-Serve” mode that maintains the internal temperature of the pre-cooked food products 15 at a set serving temperature by cycling the heat on and off. In some examples, the preparation temperature of the heating tubes 14 may reach up to 300.degree. F. (149.degree. C.). In some examples, the serving temperature of the heating tubes 14 may reach up to 240.degree. F. (116.degree. C.) in order to maintain an internal pre-cooked food product temperature in the range of 140-160.degree. F. (60-71.degree. C.). The roller grill 10 can further be designed to operate in other heating modes (e.g., a timed heating mode, an overnight heating mode, a “wake up” heating mode, and others).

In some embodiments, the roller grill 10 can include an indirect temperature sensing means 50 (e.g., an infrared laser sensor directed to a region of the heating tube array) mounted to the roller grill and configured to sense the temperature of the outer surfaces 14b of the heating tubes 14. The temperature may be polled at any rate that is capable of sending feedback to the temperature controller which controls the resistive heating elements inside the heating tubes which can be a proportional control type, or, employ proportional with integral and derivative control, or PID. In any case, by polling the outer surfaces of the heating tubes, the controller is able to regulate the relevant surface temperature for conductive heating of rotating comestibles.

In some embodiments, the heating tube array of the roller grill 10 may be divided into one or more temperature regions (e.g., Z1, and Z2) indicated by dotted lines (FIG. 1), to enable selective temperatures for one or more types of comestibles. For example, the heating tube array may include a front and rear heat zone, or, front, mid and rear heat zones controllable by a heat controller with user settable ranges, and which may include a display visible and/or controls accessible from the cabinet of the roller grill.

Top, end, and side views of a portion of the roller grill 10 utilizing a direct drive assembly are illustrated. As illustrated, the roller grill 10 includes plenums 11a and 11b enclosed within the side housings 12a and 12b in which the direct drive assembly may be disposed. The direct drive assembly may drive (e.g., rotate) the heating tubes 14 to heat and/or reheat pre-cooked food product. As illustrated, each heating tube 14 is installed over a tubular portion of a heating tube gear 17, which in turn, is installed through apertures in the side housing(s) 12a, 12b. In some embodiments, as illustrated in (FIG. 6), a bushing or heat tube retention ring 16a may also be installed through the aperture of the side housing 12a such that the heating tube 14 is disposed within the bushing and may move (e.g., rotate) within the bushing. In some embodiments, the bushing 16a may be a paired bushing, such that two heating tubes 14 are inserted through a single bushing 16.

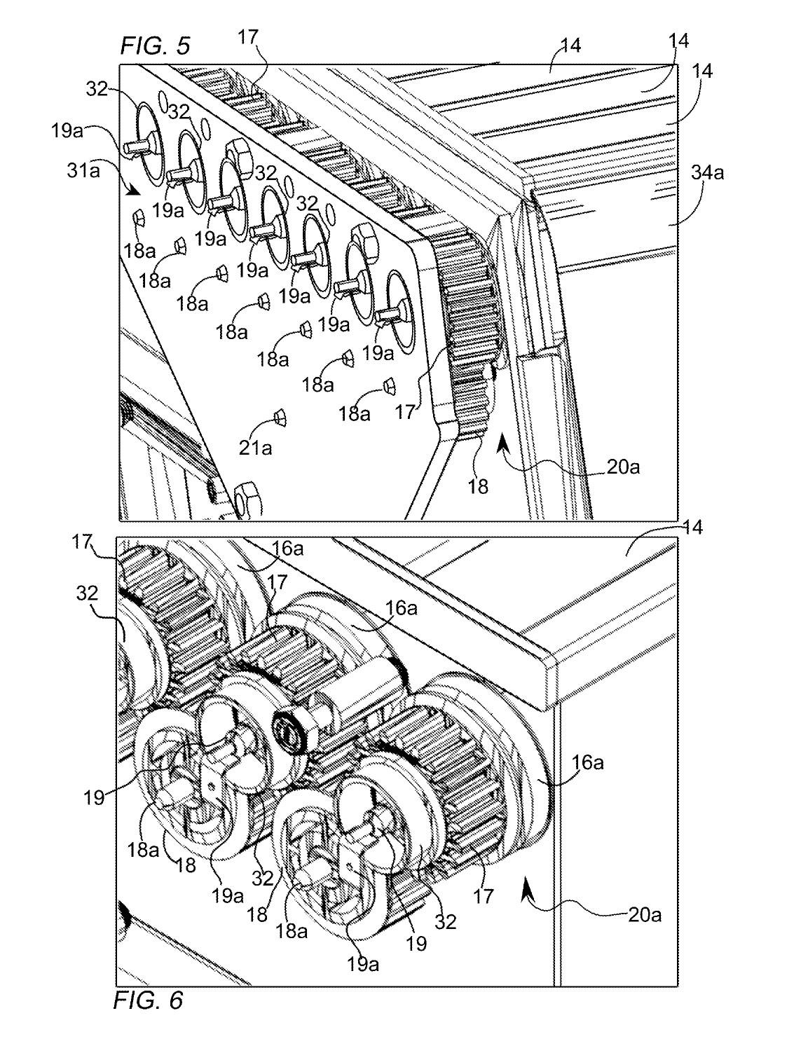

In the illustrated embodiment, a plenum panel 20a, 20b may be installed in the plenum 11a, 11b and to a surface of the side housing 12a, 12b. As illustrated, the plenum panel 20a, 20b may extend substantially an entire width of the plenum 11a, 11b and from a bottom edge of the plenum 11a to just above a midpoint of one or more idler gears 18. In some embodiments, the idler gears 18, as well as one or more transfer gears 21, may be mounted to the plenum plate 20. For instance, the gears 18 and 21 may be mounted through a mechanical fastener (FIGS. 5 and 6, 18a) disposed through an axis of the particular gear and through the plenum plate 20. In alternative embodiments, studs may be mounted (e.g., welded) on to the plenum plate 20 over which the gears 18 and 21 may be mounted. In any event, the gears 18 and 21 may be free-spinning gears mounted to the plenum plate 20 without penetrations through the side housing 12, 12b (e.g., into a sanitary volume below the pre-cooked food product 15).

In the illustrated embodiment of the roller grill 10, the plenum panel 20a, 20b includes one or more ventilation holes 28 that allow fluid (e.g., airflow) communication between the plenum 11a, 11b and a volume defined between the bottom housing 13 and the drip plate 25 and also defined between the side housing 12a, 12b. In some embodiments, airflow may be circulated between the plenum 11a, 11b and an ambient airspace through, for example, the ventilation holes 28 and one or more louvered openings in the bottom housing 13.

FIGS. 13-15 illustrates heating elements 19 (e.g., heaters with spade terminals 19a) to which wires may be coupled and thereby electrically coupled to a power source. The heating elements 19 may, in some embodiments, be an electric resistance heater installed through the heating tube 14 (e.g., all or partially) that may generate heat power to increase a temperature of an outer surface of the heating tube 14. In some embodiments, each heating tube 14 may include an individual heating element 150a. Alternatively, heating elements 19 may be installed in every other heating tube 14 (e.g., alternating heating tubes 14) or otherwise. In some embodiments, electrical wiring coupled to the respective heating elements 19 inserted through the heating tube 14 may be installed within a volume defined by the concave portion, thereby saving space within the plenum 20a.

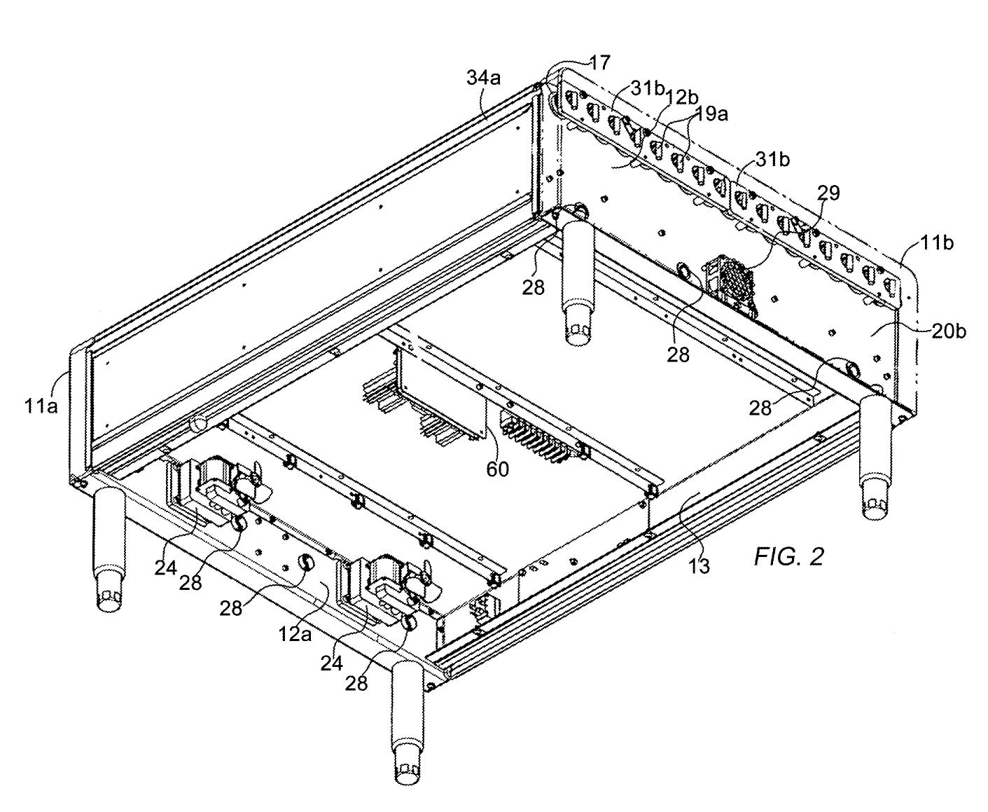

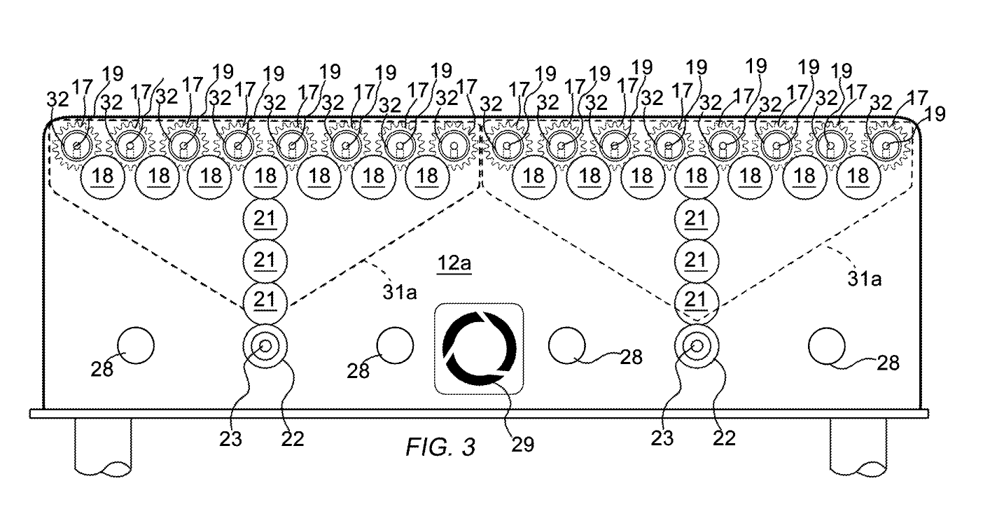

In the illustrated roller grill 10, the idler gears 18 are mounted below and engaged with the heating tube gears 17. Further, the illustrated roller grill 10 includes a drive gear 22 disposed on a shaft 23 of a motor 24 including a fan 29 (FIG. 2), that may be mounted in a bottom cavity of the roller grill 10 (defined by the side housings 12a and 12b, the drip plate 25, and the bottom housing 13). The drive gear 22 contactingly engages a transfer gear 21 within a series of transfer gears 21 to transfer rotational motion of the shaft 23 to the transfer gears 21. Although three transfer gears 21 are illustrated in FIG. 3, alternative embodiments may include more or fewer transfer gears 21. In some embodiments, one or more of the transfer gears 21 may be helical spur gears (not shown).

As illustrated, one of the transfer gears 21 may be engaged with one or more of a plurality of idler gears 18 disposed across a width of the side housing 12a. As illustrated, the idler gears 18 may be spaced evenly across the plenum plate 20a. The roller grill 10 also includes heating tube gears 17 that are coupled (e.g., inserted into) to respective heating tubes 14. For example, as illustrated, there may be a 1:1 ratio of heating tube gears 17 and heating tubes 14. In some embodiments, one or more of the idler gears 18 and/or heating tube gears 17 may be helical spur gears.

The gears 17, 18, 21, and 22 may, in some embodiments, be spur gears. In some embodiments, the gears 17, 18, 21, and 22 may be helical spur gears. In some embodiments, the gears 17, 18, 21, and 22 may be non-metallic, such as, for example, a high-temperature plastic, In some embodiments, for example, one or more gears 17 may be a high-temperature plastic such as, for example, polystyrene, nylon, TEFLON™, polyethylene, polypropylene, polyvinyl chloride, polytetrafluoroethylene (PTFE), and other plastic material) that has a continual duty max temperature rating of between about 250.degree. F. (121.degree. C.) and about 500.degree. F. (260.degree. C.). In some embodiments, for example, one or more gears 18, 21, and 22 may be a high-temperature plastic that has a continual duty max temperature rating of between about 120.degree. F. (49.degree. C.) and about 200.degree. F. (93.degree. C.).

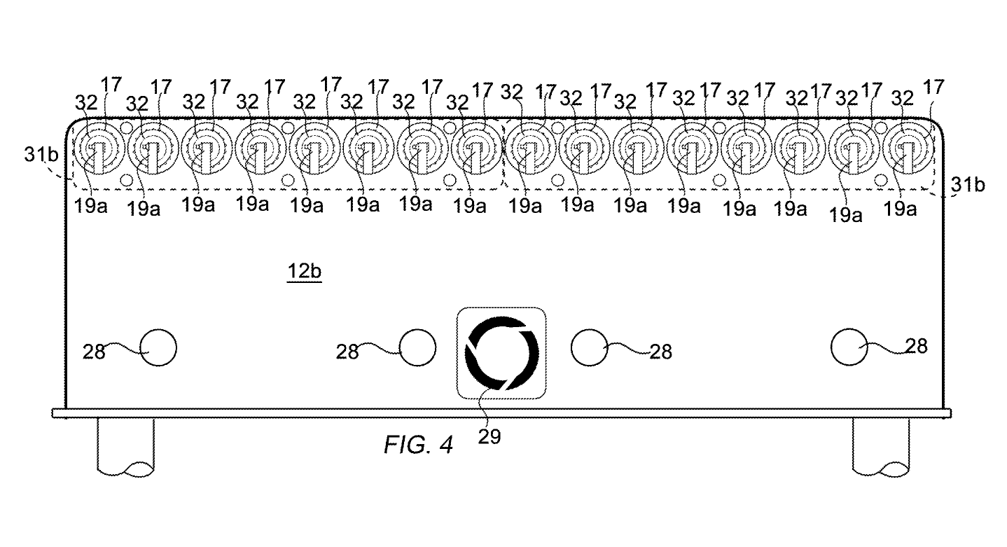

Turning to FIG. 4, a side view of a non-drive side of the roller grill 10 is illustrated. In some embodiments, only one side housing, e.g., 12a may enclose (at least partially) one or more gears and other components of the direct drive assembly. In alternative embodiments, both side housings 12a and 12b may enclose (at least partially) a portion of one or more (e.g., two) direct drive assemblies as described above. For example, there may be two motors 24 with each motor 24 driving (e.g., rotating) half of a total number of heating tubes 14 via independent direct drive assemblies. Each independent direct drive assembly may be enclosed within separate side housings 12a and/or 12b.

One of the plenums 11b enclosed by the side housing 12b is substantially free of gears and other direct drive assembly components. As illustrated, the heating tube 14 may include heating element 19 and connector 19a extending from this end of the tube 14 and may extend through the side housing 12b and be secured to the side housing 12b by a bushing 16. Bushing 16a may be sandwiched against an interior surface of the side housing 12b by a plenum plate 20b. In some embodiments, a bearing may be mounted between the bushing 16a and the plenum plate 20b so as to, for example, provide a bearing (e.g., wear) surface between the bushing 16 and plenum plate 20b.

In operation, the motor 24 of the roller grill 10 may rotate the shaft 23, which in turn rotates the drive gear 22. The drive gear 22, in turn, transfers rotational movement to the transfer gears 21. One of the transfer gears 21 is engaged with one or more of the idler gears 18 such that rotational movement is transferred from the transfer gears 21 to the engaged idler gear 18. The engaged idler gear 18 is also in contacting engagement with at least one of the heating tube gears 17, and transfers rotational movement to the at least one heating tube gear 140. Rotational movement is thus transferred to each of the idler gears 18 and heating tube gears 17, thereby rotating the heating tubes 14.

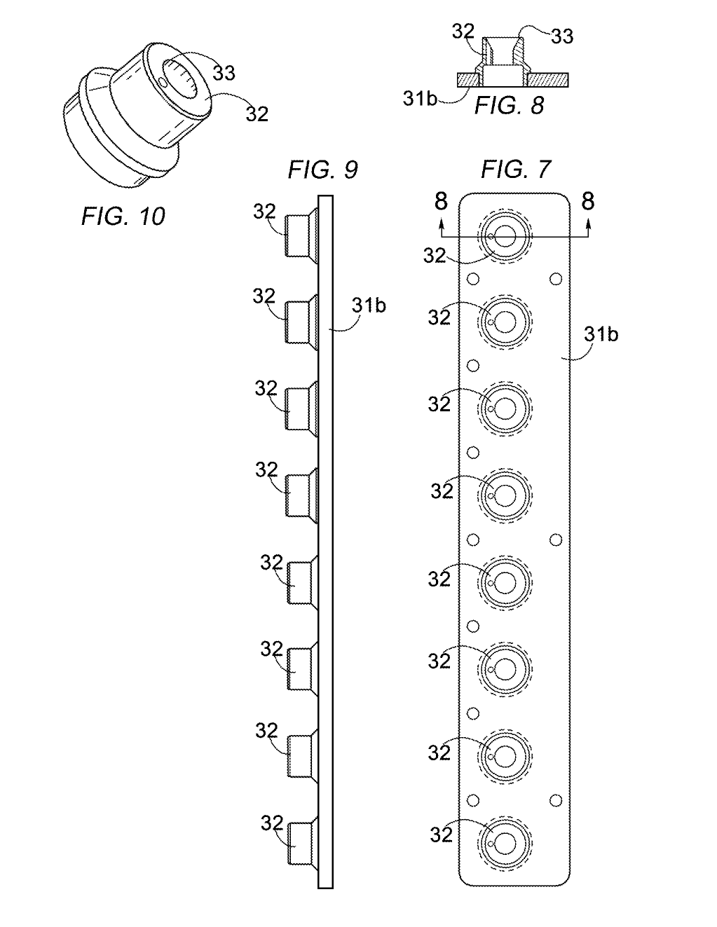

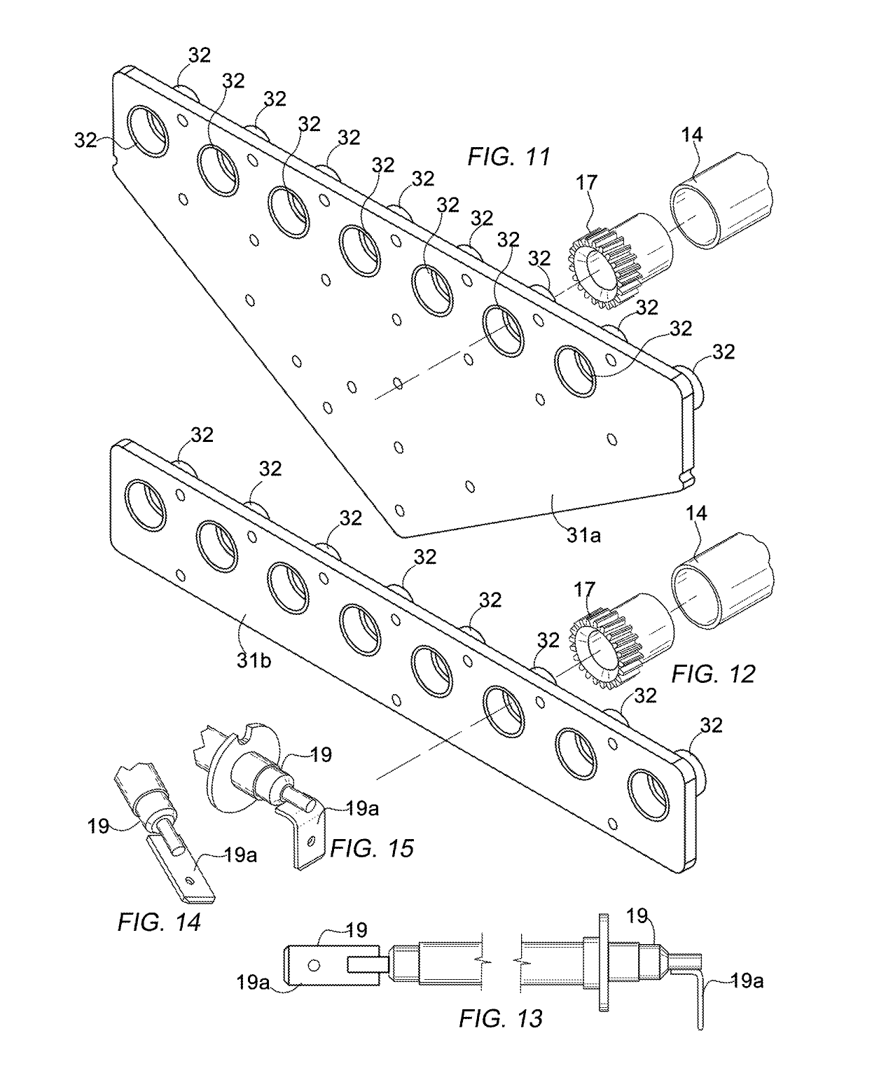

Turning to FIGS. 5-15, mounting plate 31a, 31b possess a series of apertures into which a series of heat tube axles 32 is fitted. Each heat tube axle 32 is adapted to accept a distal end of a heat tube gear having a interior shape that mates with the tube axle and permits free rotation of the tube gear 17 about the axle 32. The tube gears may be simple spur gears, helical spur gears or other type of gear that would be appreciated by those having skill in the art and benefit of this disclosure. The tube axles also support a heating element 19 longitudinally positioned inside of each heat tube with connectors 19a; shown in the illustrated embodiment as spade connectors, extending beyond the mounting plates 31a, 31b. A bushing 16a may surround an aperture in the plenum panel 20a, 20b, and provide support for the heat tube at the nexus of the heat tube and the plenum aperture. Bushing 16a may be a high temperature resistant polymer such as a silicone or other polymer. Furthermore, the heat tube contacting surface of the bushing may be minimized to reduce frictional resistance. FIG. 10 is a perspective view of a heat tube axle that is adapted to fit into apertures within mounting plates 31a, 31b. While in the embodiment illustrated, the heat tube axle has a generally fructo-conical shape at one end, other geometries may suggest themselves to those having skill in the art. Axles 32 are preferably of a heat resistant polymer possessing a low coefficient of friction that permits easy rotation of the tube gears 17 thereabout. Mounting plates are preferably of a heat resistant material having a low to moderately low linear temperature expansion coefficient. In the embodiment shown, the axle mounts eliminate gear mash, making the alignment perfect which reduced the drag to less than 1.5 lbs per square foot.

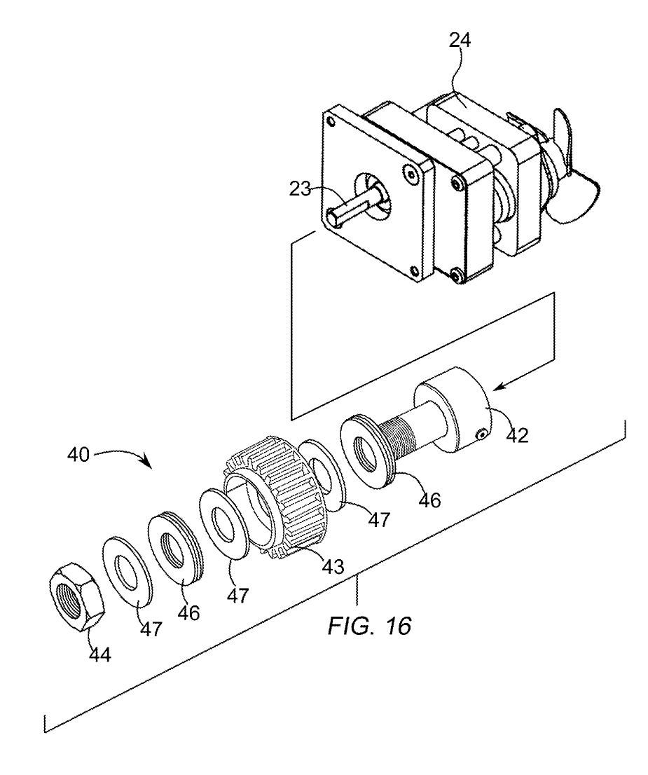

Turning to FIG. 16, a slip gear 40 or clutch is shown being mountable to an output shaft of motor 24 which is typically mounted in the space beneath the drip plate as shown in FIG. 2 with the output shaft extending beyond plenum panel 20a. The slip gear includes a clutch sleeve 42 that can be affixed to the output shaft of motor 24, a clutch gear 43, a clutch nut 44, with a plurality of stacked Bellville washers 46 and clutch washer 47 disposed between the clutch nut 44 and the generally medially positioned clutch gear 43, and, the clutch sleeve 42 and the clutch gear 43. The slip gear prevents damage from gear mash by disengaging power from the motor(s) and the clutch sleeve and thereby the drive transmission, in the event that one or more heating tubes or gears are jammed or otherwise prevented from rotation.

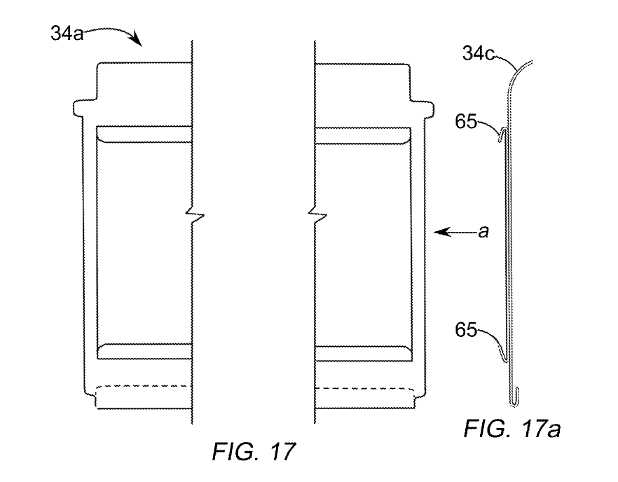

FIGS. 17 and 17a depict respectively, a partial plan view and an end view taken in the direction of arrow (a), of an exemplary heat containment panel 34a, 34b that is mountable to the front and rear of the roller grill 10. The uppermost portion of the panel 34c curves toward the heating tubes 14 and is adapted to reduce heat losses by convection and radiation. In effect, the panel(s) heat losses from the front and back borders of the heat tube array and stabilize the temperature of the first row and last row of heating tubes thereby providing a heating surface with a generally low delta T across the surface. In the particular illustrated embodiment, heat losses from the front and back rows of heat tubes were reduced by 40 percent when compared to analogous embodiments lacking the heat containment panel with curving uppermost portion resulting in non-trivial energy savings.

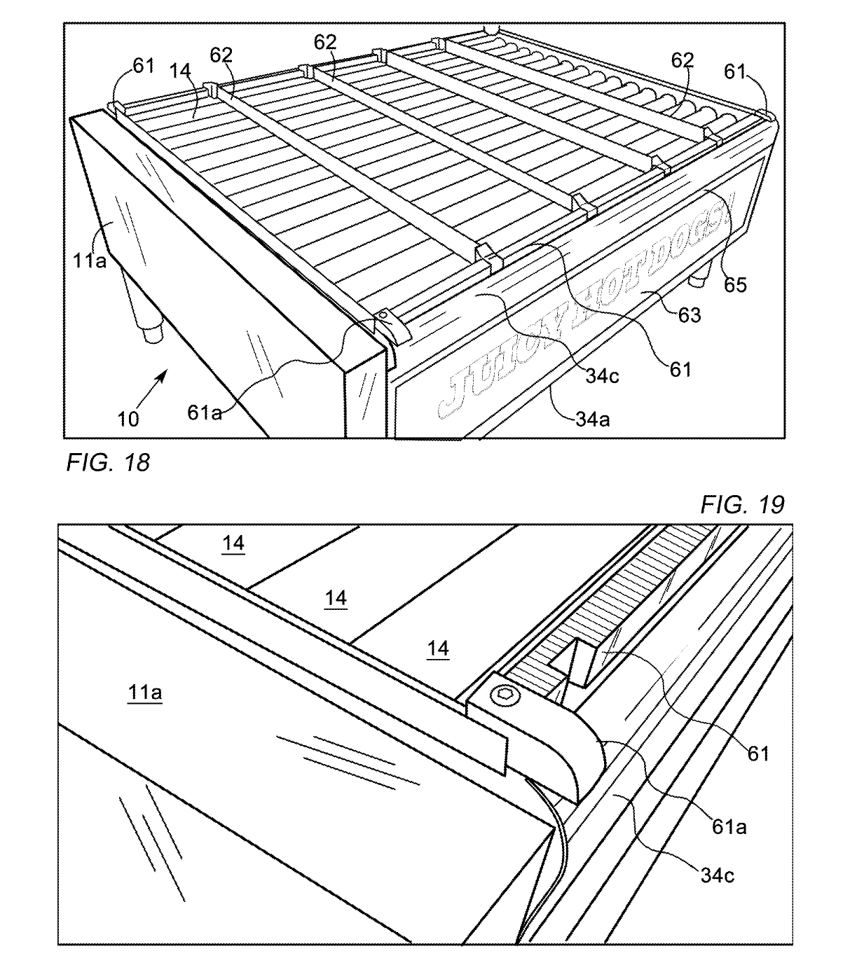

FIGS. 18 and 19 depict respectively, a perspective view of the roller grill 10 showing a slidable divider frame 61 transversely arranged atop the heating tube array such that portions of the divider frame are supported by the front and rear heat containment panels 34a, 34b, wherein the slidable dividers are suspended slightly above the heating tubes 14 surface. The slidable dividers keep food evenly spaced and may be used to separate different types and lengths of comestible. The curving ends 34c of the heat containment panels extend above the surface of the heating tubes to serve as a guard to prevent customer contact with the heated surface of the heating tube array, and obstruct the heat settings controls for the roller grill to prevent tampering. In addition, the heat containment panels also provide an attachment surface including with flanges 64 configured to accept snap-in readily replaceable POP type advertising signs 63.

While the invention has been described by the embodiments given, it is not intended to limit the scope of the invention to the particular form set forth, but on the contrary, it is intended to cover such alternatives, modifications, and equivalents as may be included within the spirit and scope of the invention as defined by the appended claims.

1. A roller grill for heating a pre-cooked food product, comprising:
a housing structure adapted to support the roller grill;
a plurality of tubes having opposite ends and outer surfaces adapted to transfer heat to a pre-cooked food product; a plurality of tube gears including at least one tube gear having a tube mounting end mounted on an end of a corresponding tube and the at least one tube gear further including a recessed portion adapted to receive a tube axle portion wherein a connection of the tube gear and the tube axle permits at least angular movement between the tube gear and the tube axle;
and a drive assembly, comprising:
at least one motor having a shaft adapted to rotate at a first rotational speed, the shaft engaged with a gear clutch coupled to a drive gear;
a fan to circulate airflow between a volume of a side housing of the housing structure and an ambient space to cool a plenum panel mounted in the side housing;
a plurality of idler gears mounted to a portion of the housing structure and contactingly engaged with the plurality of tube gears, the idler gears adapted to transfer a rotational power from the motor to all of the plurality of tube gears at a second rotational speed and at a common rotational direction;
front and rear heat containment panels with an uppermost curving portion; and, wherein the drive gear is adapted to transfer the rotational power from the motor to the plurality of idler gears;
and at least one transfer gear in contacting engagement with at least one idler gear of the plurality of idler gears and adapted to transfer the rotational power from the drive gear to the at least one idler gear, wherein the plenum panel serves as a heat sink to receive heat from one or more of the plurality of tubes, the plenum panel mounted within the volume at least partially defined by a side panel of the housing structure, and at least one of the plurality of idler gears is mounted to the plenum panel, the plenum panel comprising at least one aperture permitting airflow between the volume and the ambient space, and the motor and the fan are mounted beneath the plurality of tubes in a bottom housing of the housing structure to permit airflow between the side housing and the ambient space.

2. The roller grill of claim 1 further comprising at least one mounting plate for seating of a plurality of tube axles.

3. The roller grill of claim 2 wherein ends of each gear of the plurality of tube gears reside over each tube axle of the plurality of tube axles.

4. The roller grill of claim 1, wherein the first and second rotational speeds are substantially identical.

5. The roller grill of claim 1, wherein the second rotational speed is less than the first rotational speed, and the at least one transfer gear comprises at least one reduction gear adapted to reduce the first rotational speed to the second rotational speed.

6. The roller grill of claim 1, wherein the plurality of tubes are mounted through the side housing, and the plurality of idler gears are mounted to the side housing.

7. The roller grill of claim 1 further comprising an indirect temperature sensor for measuring surface temperature of the tubes.

8. The roller grill of claim 1 further comprising a plurality of moveable transversely mountable dividers that are suspended above the surface of the heating tubes.

9. The roller grill of claim 1 wherein a heat containment panel possesses an uppermost curving end at the front or back of the housing structure, and wherein the curving end extends above the level of the heating tubes.

10. The roller grill of claim 1, wherein at least one of the tube gears and the idler gears comprises a spur gear.

11. The roller grill of claim 1, further comprising plural heat zones.

12. A roller grill for heating a pre-cooked food product, comprising:
a housing structure adapted to support the roller grill;
a plurality of tubes and disposed between opposed portions of the housing structure and having outer surfaces adapted to transfer heat to the pre-cooked food product;
a plurality of heating elements, each heating element disposed within each tube;
a plurality of tube gears, each tube gear including a mounting portion adapted to mount on an end of a corresponding tube and a receiving portion for mounting circumjacently about a tube axle wherein a connection of the tube gear and the tube axle permits at least angular movement between the tube gear and the tube axle;
a motor disposed within a cavity of the housing structure, the motor comprising a motor shaft and adapted to generate a rotational power through the motor shaft at a first rotational speed;
a fan coupled to the motor;
a drive sub-assembly including a slip gear clutch coupled to the motor and adapted to transfer the rotational power from the shaft to the plurality of tube gears at a second rotational speed;
heat containment panels at front and rear of the roller grill that reside at a height greater than that of the heat tubes with an uppermost section inclined toward the heat tubes; and,
a plenum of the housing structure adjacent the tube gears, the plenum at least partially defined by a side housing of the housing structure, wherein a plenum panel serves as a heat sink to receive heat transferred from the plurality of tubes through the plenum, and at least one aperture permits airflow between the plenum and an ambient space, wherein the motor and the fan are mounted in a bottom portion of the housing arranged beneath the plurality of tubes, the fan positioned to circulate airflow between the plenum and the ambient space.

13. The roller grill of claim 12, wherein the first and second rotational speeds are substantially identical.

14. The roller grill of claim 12 further comprising a plurality of self-centering tube axles.

15. The roller grill of claim 12 wherein ends of the tubes reside over the tube axles.

16. The roller grill of claim 12 further comprising at least one tube axle mounting plate.

17. The roller grill of claim 12 further comprising an indirect temperature sensor for measuring surface temperature of the tubes.

18. The roller grill of claim 12 further comprising a plurality of moveable transversely mountable dividers that are supported above the surface of the heating tubes.

19. The roller grill of claim 12, wherein the drive sub-assembly comprises: a plurality of idler gears mounted to a portion of the housing structure and contactingly engaged with the plurality of tube gears, the idler gears adapted to transfer the rotational power from the motor via the slip gear clutch to the plurality of tube gears at the second rotational speed.

20. The roller grill of claim 12, further comprising plural heat zones.
